(19) United States
(12) Patent Application Publication
(10) Pub. No.: US 2020/0233647 A1
(43) Pub. Date: Jul. 23, 2020

(54) METHOD FOR DEVELOPING STANDARDIZED SOFTWARE MODULE AND METHOD FOR DEVELOPING SOFTWARE SYSTEM

(71) Applicant: SHANGHAI VOWGROUP COMPUTER SCIENCE AND TECHNOLOGY CO., LTD, Shanghai (CN)

(72) Inventors: XiaoBing WEN, Shanghai (CN); Liang LI, Shanghai (CN); WeiBing WEN, Shanghai (CN)

(21) Appl. No.: 16/652,848

(22) PCT Filed: Jan. 28, 2019
(86) PCT No.: PCT/CN2019/073449

§ 371 Date: Apr. 1, 2020

(30) Foreign Application Priority Data
May 18, 2018 (CN) 201810478295.1

(51) Int. Cl. G06F 8/36

(52) U.S. Cl. CPC G06F 8/36

(57) ABSTRACT

A method for developing a standardized software module and a method for developing a software system. The method for developing a standardized software module involves defining eight elements for the standardized software module, including attributes, service methods, plugs, slots, signals, signal slots, notices, and notice slots. The attributes, the service methods and the notices are presented as texts. Different standardized software modules are in hardwired connection through the plugs and the slots, in flexible connection through the signals and the signal slots, and in loose dynamic connection through the notices and the notice slots. The standardized software module includes a plug representing the software itself and at least one of the eight elements. Plural said standardized software modules are assembled into a new standardized software module.

### BACKGROUND OF THE INVENTION

### 1. Technical Field

The present invention relates to the technical field of software, and more particularly to a method for developing a standardized software module and a method for developing a software system.

### 2. Description of Related Art

Software crisis is a term referring to a series of serious problems occurring during development and maintenance of software caused by unmet growing requirements of computer software due to outdated mode of software production. Currently, with the rapid development of computer hardware technology, there are more and more hardware platforms for software to operate thereon. The available platforms rapidly expand from traditional PCs to various small, mobile devices and large server clusters. To respond to such a trend, software development is conducted in an increasingly large scale. Particularly, new technologies, such as cloud technology, embedded technology, IoT, Industry 4.0 and artificial intelligence, are springing up to make software more and more sophisticated. Under this situation, software crisis is not mitigated but gets aggravated instead, as proven by the increasing working hours in software companies in China.

Presently, the mainstream approach to software reuse adopted in the industry is component-based methods for software development. The term “component” refers to a software entity in a software system that has relatively independent functions, and use contract-designated interface while being is easily identifiable, obviously context-dependent, independently deployable, and assemable. Some dominant component standards nowadays include:

1. EJB/J2EE component standards: J2EE is a set of specifications and technology for Java enterprise computation platforms developed by SUN (now belonging to Oracle Corporation) to provide component-based solutions for enterprise-oriented distributed application development. Component models are structurally solid and supported by a mature development environment and form one of the mainstream distributed component technologies. However, J2EE specifications are disadvantageously huge and complicated, so the development and deployment are troublesome, challenging software developers with a steep learning curve. For enterprise application development, Spring and Hibernate development frameworks are deemed more flexible, simpler and faster than J2EE.

2. CORBA component standards: CORBA is a set of component specifications developed by OMG for development and configuration of server distributed applications. CORBA standards are mainly composed of three layers: object request brokers, common object services and common facilities. CORBA is large and comprehensive, and has good interoperability and developability. However, it is also huge and complicated, leading to a steep learning curve. In addition, CORBA technology and standards have been evolved in a relatively slow pace. Specifically, CORBA specifications were soon updated from version 1.0 to 2.0, but release of the later versions has been slowed down, making it less extensively applied.

3. COM/.NET component standards: COM (Component Object Model) is a component object model developed by Microsoft and provides a set of specifications for interface implementation. COM component technology is intended to solve the problem that release of C++ dynamic libraries lacks for binary-level standards and separates interface and implementation by means of interface specification standards. Microsoft has defined two COM-supporting interchange formats, namely interface definition languages (IDL) and type libraries (TLB). However, the two interchange formats make COM less standardized and less scalable, becoming fatal defects of COM. Microsoft has expanded DCOM (distributed COM) and transactional servers MTS using COM technology, which are collectively called as COM+. On this basis, Microsoft further has further developed .NET framework as an environment of the next generation for development and execution of components. NET Framework mainly includes three aspects: CLR (Common Language Runtime), the service framework, and application templates for the upper two categories, namely the traditional Windows application program template sand ASP.NET-based web-oriented network application program templates. As one of the mainstream distributed component technologies, .NET component models have a mature development environment and extensive usages. The main issue related to a .NET component model is that it is designed for Windows operating platforms and does not support embedded systems and other operating systems. Additionally, .NET component model specifications are more complicated and intended to serve professional software developers.

While the foregoing component models are well developed from the perspective of software implementation, they are far from perfect from the perspective of software reuse.

For large-scale reuse of software, one of the most effective paths is adoption of methods based on software product lines. According to Software Engineering Institute (SEI), Carnegie Mellon University, by introducing software product line engineering, software enterprise can benefit from: (1) 10× or more production efficiency; (2) 10× or more product quality improvement; (3) 60% reduction of costs; (4) 87% reduction of labor needs; (5) up to 98% reduction of time to market; and (6) fast entry into new markets in only months but not years.

Software reuse means that only software whose assets are adaptive enough is applied to different products. Only when a software unit satisfies the same definition and implementation standards, and has sufficient adaptability, the software unit can be put into large-scale reuse. This is the critical point of engineering practice of software product lines. Nevertheless, rather than being properly embodied in the three mainstream component standards, the requirement of component adaptability has been concerned from the perspective of software development and since the intended participants are professional software developers, the specification standards are too complicated for people not specializing in computer science to follow.

On the other hand, software product line engineering is theoretically solider and is more about providing guidance throughout software development from the perspective of software engineering. Its implementation, however, requires developers to select proper technology systems. This creates a predicament that an enterprise wanting to implement software product line engineering can find the traditional component system being excessively complicated and very difficult to implement. Hence, there is a need of a simple, easy to implement and reusable software module in the field of software product line engineering.

### SUMMARY OF THE INVENTION

For addressing the issues of the prior art, the present invention provides a method for developing a standardized software module and a method for developing a software system that are simple, easy to implement, and capable of addressing large-scale reusability of software, while reducing development costs of software and improving development quality and efficiency of software, thereby achieving specialized use, social collaboration and industrialized production of software.

The disclosed method for developing a standardized software module involves defining eight elements for the standardized software module, including attributes, service methods, plugs, slots, signals, signal slots, notices, and notice slot,

in which the attributes, the service methods and the notices are presented as texts,

the notice slots being used for subscribing to notices issued by another standardized software module,

different said standardized software modules being in hardwired connection with each other through the plugs and the slots,

different said standardized software modules being in flexible connection with each other through the signals and the signal slots,

different said standardized software modules being in loose dynamic connection with each other through the notices and the notice slots,

each said standardized software module including a plug representing the software itself and at least one of the eight elements, and

plural said standardized software modules being configured to be assembled into a new standardized software module.

Further, the disclosed method for developing a standardized software module may further have such a feature that the slots include a singleton slot for only connecting one said plug and a prototype slot for connecting plural said plugs.

Further, the disclosed method for developing a standardized software module may further have such a feature that only the plug and the slot being of an identical type are allowed to be connected with each other.

Further, the disclosed method for developing a standardized software module may further have such a feature that only the signal and the signal slot being of an identical type are allowed to be connected with each other.

Further, the disclosed method for developing a standardized software module may further have such a feature that one said signal in the standardized software module is allowed to be connected with plural said signal slots in other said standardized software modules.

Further, the disclosed method for developing a standardized software module may further have such a feature that the standardized software module is configured to issue said notices that are network-transparent, and the standardized software module uses the notice slots to subscribe to notices that are issued by said standardized software modules running on external devices operating locally or on a network and are of the same type as the notice slot.

Further, the disclosed method for developing a standardized software module may further have such a feature that each said standardized software module is configured to be visualized for display.

Further, the disclosed method for developing a standardized software module may further have such a feature that different said standardized software modules are assembled into said new standardized software module by means of visualization or codes.

Further, the disclosed method for developing a standardized software module may further have such a feature that the standardized software module is exposed to the standardized software modules of different types through the plugs.

Further, the disclosed method for developing a standardized software module may further have such a feature that each said element is singular or plural in the standardized software module.

The present invention further provides a method for developing a software system, wherein: the software system is an ordered combination of said standardized software modules developed using the method as described previously.

The present invention has the following advantages:

In the disclosed method for developing a standardized software module, eight elements are defined for the standardized software module. Every standardized software module includes a plug representing the software itself, and at least one of the eight elements. Different standardized software modules may be in hardwired connection with each other through the plugs and the slots, in flexible connection with each other through the signals and the signal slots, and in loose dynamic connection with each other through the notices and the notice slots. The standardized software module, as a reusable software basic unit, can be combined with other standardized software modules in a flexible and dynamic way to form a new standardized software module. By simply assembling these standardized software modules into an ordered combination, a software system can be developed. Thus, method for developing a standardized software module of the present invention is simple, easy to implement, and capable of addressing large-scale reusability of software, so as to reduce development costs of software and improving development quality and efficiency of software, thereby achieving specialized use, social collaboration and industrialized production of software.

The method for developing a software system of the present invention uses standardized software modules developed using the method for developing a standardized software module to form the software system, so as to address large-scale reusability of software, reduce development costs of software, and improve development quality and efficiency of software, thereby achieving specialized use, social collaboration and industrialized production of software.

### BRIEF DESCRIPTION OF THE DRAWINGS

FIG. 1 is a graphic representation of a standardized software module;

FIG. 2 is a visualized assembly drawing of two standardized software modules; and

FIG. 3 illustrates a development process of a software system of the present invention.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

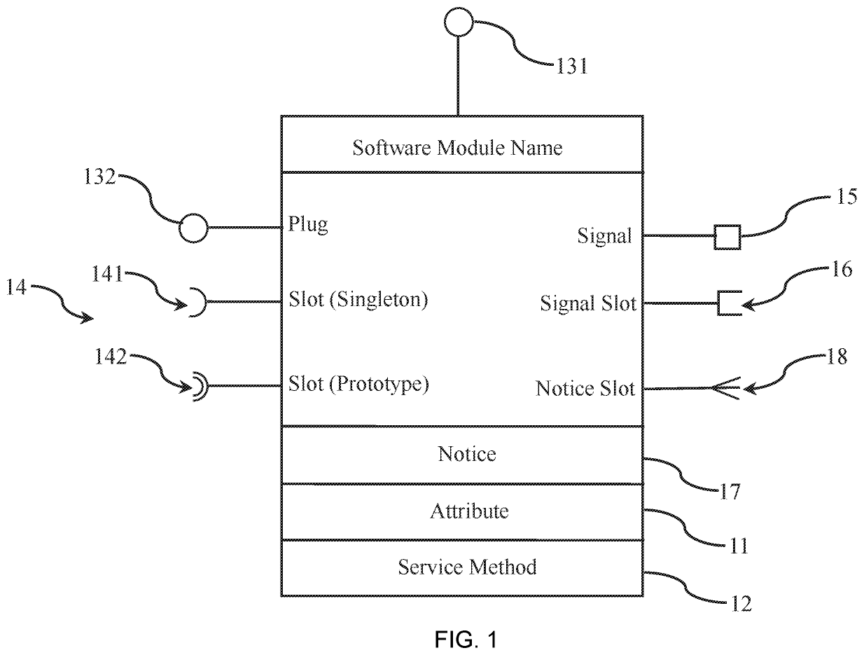

The method for developing a standardized software module, as shown in FIG. 1, defines eight elements for the standardized software module, including attributes 11, service methods 12, plugs, slots 14, signals 15, signal slots 16, notices 17 and notice slots 18.

The attributes 11, the service methods 12 and the notice 17 are all in the form of texts. Therein, the attributes 11 and the service methods 12 can be folded down and up. Every standardized software module is capable of issuing notices, and the notices are the contents contained in the notices 17 of the standardized software module. The notice slots 18 are used to subscribe to notices issued by other standardized software modules. In the present embodiment, a notice slot can only subscribe to notices that are issued by other standardized software modules and are of the same type as the notice slot. Different software modules are in loose dynamic connection with each other through the notices 17 and the notice slots 18. A notice and a notice slot do not have to be in connection, and they are network-transparent. In other words, the standardized software module is configured to issue network-transparent notices and a notice slot 18 can subscribe to notices that are issued by standardized software modules run on other machines and are of the same type as the notice slot through the local machine and over a network.

Different standardized software modules are hardwired with each other through plugs and slots 14. In the present embodiment, connection between a plug and a slot 14 can only be established when they are of the same type. A plug may represent the standardized software module itself or a standardized software module of another type. As shown in FIG. 1, the plug 131 represents the standardized software module itself, and the plug 132 represents a standardized software module of another type. There are two types of slots 14, namely singleton slots 141 and prototype slots 142. A singleton slot 141 can only receive one plug, while a prototype slot 142 can receive plural plugs.

Different standardized software modules are in flexible connection with each other through the signals 15 and the signal slots 16. In the present embodiment, connection between a signal 15 and a signal slot 16 can only be established when they are of the same type. A signal 15 may be in connection with plural signal slots 16.

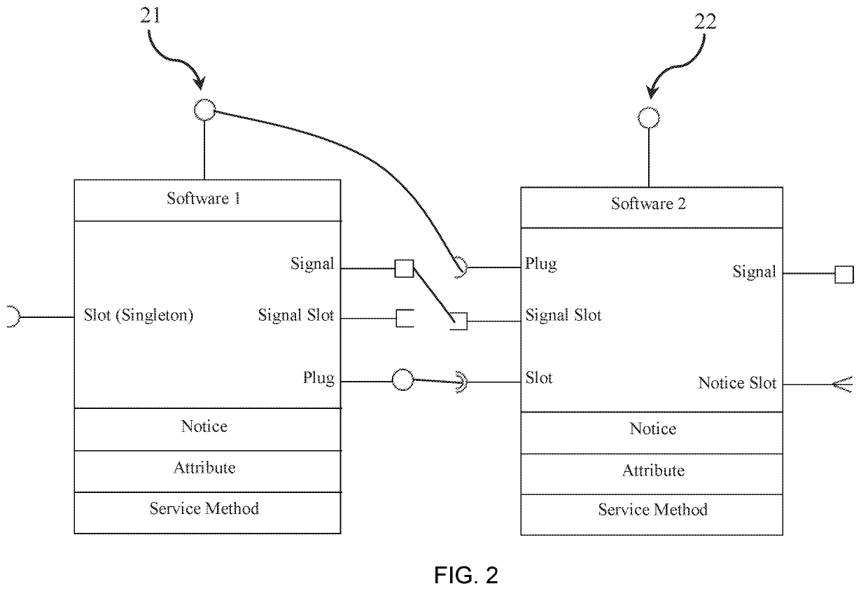

Every standardized software module includes one plug 131 representing the software itself and at least one of the eight elements. A standardized software module, regardless of its type, has a plug as default. For example, the default plug 131 represents the standardized software module itself, and can be in connection with a slot of the same type in another standardized software module. Every standardized software module may be exposed to standardized software modules of different types through plugs. For example, as shown in FIG. 2, the standardized software module is exposed to another standardized software module represented by the plug 132 through the plug 132. A standardized software module may be stated as being singleton during its instantiation, meaning that it has no duplicate in the system.

The standardized software module may be visualized for display and operation. Different software modules may be assembled into a new standardized software module through either visualization or coding. The new standardized software module so assembled still has at least one of the eight elements of the standardized software modules.

FIG. 2 is a visualized assembly drawing of two standardized software modules. The standardized software modules 21 and 22 are in hardwired connection with each other through the plug and the slot, in flexible connection with each other through the signal and the signal slot, and in loose dynamic connection with each other through the notice and the notice slot. The two standardized software modules so assembled form a new standardized software module. The formed new standardized software module may be reused and further assembled.

Every element of the standardized software module may be one or plural. For example, one standardized software module may include plural plugs and slots of different types.

The method for developing a software system provides a software system that is an ordered combination of plural standardized software modules developed using the foregoing method for developing a standardized software module.

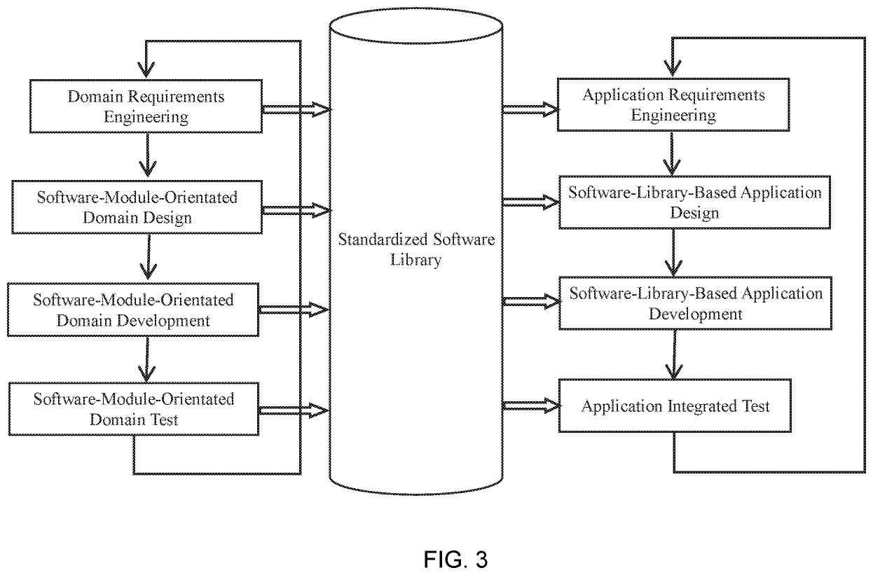

Software development involves two processes, namely reuse-oriented development and reuse-based development. In the present invention, the phrase “developing a software system” refers to the process of development, reuse and assembly of standardized software modules. As shown in FIG. 3, standardized software modules are developed according to a set of unified specifications standards, namely the foregoing method for developing a standardized software module development, and then collected to form a standardized software module library. For application, the standardized software modules in the standardized software module library can be orderedly combined into a software system.

For example, a collection and control system to be used in an industrial site may be developed using the disclosed method for developing a software system. An “automobile assembly workstation quality monitoring system” used by some automobile manufacturer is described below as an example. Contents for the system to implement are: collecting historical data of vehicle test items, comparing technical indicators of test data, analyzing and identifying abnormal parameters, generating a list of faults, and producing test records through a CAN bus protocol. The system should be able to playback data and display test data through a large screen. Development of the system is accomplished by orderedly combining standardized software modules such as a standardized software module library for data, a standardized software module library for business, a standardized software module library for interface, a standardized software module library for field bus protocol, a standardized software module library for configuration, into the automobile assembly workstation quality monitoring system.

The disclosed method for developing a software system may also be used to develop an enterprise business system. One example is an “enterprise quality management system,” which benefits from numerous R&D work results and product design data of non-standard custom products collected by research institutes in China. These data files usually contain 2D and 3D engineering drawings, design files, computation reports, experiment reports, product manual, maintenance manual and design specifications, standards related to the products. Contents for the system to implement are: classifying and organizing the foregoing data reasonably, setting up databases by type (such as parts, components, products, etc.), providing state control and authority management for the data, providing search and statistics of the data, and standardized-systematic-modularized management for common components, thereby improving product data management in terms of efficiency, accuracy, reliability and controlled security, so as to overcome problems related to the traditional manual management methods and bring information management of quality into a new level. Development of the system is accomplished by orderedly combining standardized software modules such as applications a standardized software module for networks, a standardized software module for data, a standardized software module for business, a standardized software module for interface, a standardized software module for reports, into an enterprise quality management system.

The present invention has been described with reference to the preferred embodiments and it is understood that the embodiments are not intended to limit is the scope of the present invention. Moreover, as the contents disclosed herein should be readily understood and can be implemented by a person skilled in the art, all equivalent changes or modifications which do not depart from the concept of the present invention should be encompassed by the appended claims.

1. A method for developing a standardized software module, comprising:
defining eight elements for the standardized software module, including attributes, service methods, plugs, slots, signals, signal slots, notices, and notice slots,
wherein the attributes, the service methods and the notices are presented as texts,
the notice slots being used for subscribing to notices issued by another standardized software module,
different said standardized software modules being in hardwired connection with each other through the plugs and the slots,
different said standardized software modules being in flexible connection with each other through the signals and the signal slots,
different said standardized software modules being in loose dynamic connection with each other through the notices and the notice slots,
each said standardized software module including a plug representing the software itself and at least one of the eight elements, and
plural said standardized software modules being configured to be assembled into a new standardized software module.

2. The method of claim 1, wherein:
the slots include a singleton slot for only connecting one said plug and a prototype slot for connecting plural said plugs.

3. The method of claim 1, wherein:
only the plug and the slot being of an identical type are allowed to be connected with each other.

4. The method of claim 1, wherein:
only the signal and the signal slot being of an identical type are allowed to be connected with each other.

5. The method of claim 4, wherein:
one said signal in the standardized software module is allowed to be connected with plural said signal slots in other said standardized software modules.

6. The method of claim 1, wherein:
the standardized software module is configured to issue said notices that are network-transparent, and the standardized software module uses the notice slots to subscribe to notices that are issued by said standardized software modules running on external devices operating locally or on a network and are of the same type as the notice slot.

7. The method of claim 1, wherein:
each said standardized software module is configured to be visualized for display.

8. The method of claim 1, wherein:
different said standardized software modules are assembled into said new standardized software module by means of visualization or codes.

9. The method of claim 1, wherein:
the standardized software module is exposed to the standardized software modules of different types through the plugs.

10. The method of claim 1, wherein:
each said element is singular or plural in the standardized software module.

11. A method for developing a software system, wherein:
the software system is an ordered combination of said standardized software modules developed using the method of claim 1.
